(19) United States
(12) Patent Application Publication
(10) Pub. No.: US 2025/0275076 A1
(43) Pub. Date: Aug. 28, 2025

(54) POWER CONVERSION DEVICE

(71) Applicant: DENSO CORPORATION, Kariya-city (JP)

(72) Inventors: Hiroki UMEDA, Kariya-city (JP); Eiji Felipe IDO, Kariya-city (JP)

(73) Assignee: DENSO CORPORATION, Kariya-city (JP)

(21) Appl. No.: 19/206,328

(22) Filed: May 13, 2025

Related U.S. Application Data
(63) Continuation of application No. PCT/JP2023/041722, filed on Nov. 21, 2023.

(30) Foreign Application Priority Data
Dec. 27, 2022 (JP) 2022-210361

(51) Int. Cl. H05K 7/14; H02M 7/00; H05K 7/20

(52) U.S. Cl. CPC H05K 7/1432; H05K 7/209; H05K 7/20927; H02M 7/003

(57) ABSTRACT

A power conversion device includes: a base having a first cooler; a semiconductor module stacked on the first cooler; a frame arranged to surround the semiconductor module and fixed to the base; and an electrically insulating sealing member filled in a region surrounded by the frame to seal the main terminal. The frame includes an outer peripheral wall portion that surrounds the semiconductor module in a plan view, and an extension portion. The extension portion is made of an electrically insulating material, extends from the outer peripheral wall portion to a position that overlaps with the semiconductor module in the plan view, and is positioned between the semiconductor module and the first cooler in the stacking direction.

### CROSS REFERENCE TO RELATED APPLICATION

The present application is a continuation application of International Patent Application No. PCT/JP2023/041722 filed on Nov. 21, 2023, which designated the U.S. and claims the benefit of priority from Japanese Patent Application No. 2022-210361 filed on Dec. 27, 2022. The entire disclosures of all of the above applications are incorporated herein by reference.

### TECHNICAL FIELD

The present disclosure relates to a power conversion device.

### BACKGROUND

A conventional power conversion device includes a power module and a cooling passage formation body (cooler) that cools the power module. The power module is provided with a plurality of main terminals.

### SUMMARY

A power conversion device according to an aspect of the present disclosure may include: a base provided with a cooler; a semiconductor module that includes a body portion including a semiconductor element, and a plurality of main terminals including parallel terminals arranged side by side with each other and protruding from the body portion, the semiconductor module being stacked on the cooler; a frame fixed to the base and arranged around the semiconductor module in a plan view of a stacking direction in which the cooler and the semiconductor module are stacked; and a sealing member having an electrically insulation and filled in a region that is surrounded by the frame and seals the main terminal. The frame may be provided with (i) an outer peripheral wall portion that surrounds the semiconductor module in the plan view, and (ii) an extension portion that is made of an electrically insulating material, extends from the outer peripheral wall portion to a position that overlaps with the semiconductor module in the plan view, and is positioned between the semiconductor module and the cooler in the stacking direction.

### BRIEF DESCRIPTION OF THE DRAWINGS

Objects, features, and advantages of the present disclosure will become more apparent from the following detailed description made with reference to the accompanying drawings, in which:

FIG. 1 is a diagram of a circuit configuration and a drive system of a power conversion device according to a first embodiment;

FIG. 2 is a plan view of the power conversion device;

FIG. 3 is a cross-sectional view taken along a line III-III of FIG. 2;

FIG. 4 is a cross-sectional view taken along a line IV-IV of FIG. 2;

FIG. 5 is an enlarged view of a region V in FIG. 3;

FIG. 6 is a diagram of a along-surface distance when a gap occurs;

FIG. 7 is a diagram of a comparative example;

FIG. 8 is a diagram of a power converter according to a second embodiment;

FIG. 9 is a diagram of a through hole providing an adhesive area;

FIG. 10 is a diagram of a power converter according to a third embodiment;

FIG. 11 is a diagram of a power converter according to a fourth embodiment; and

FIG. 12 is a diagram of a power converter according to a fifth embodiment.

### DESCRIPTION OF EMBODIMENTS

A relative power conversion device includes a power module and a cooling passage formation body (cooler) that cools the power module. The power module has a plurality of main terminals. The main terminals protrude from a body portion including a power semiconductor element. The main terminals include parallel terminals arranged side by side. Although the inductance can be reduced by reducing a gap between the parallel terminals, the main terminals are necessary to be sealed with a sealing member such as gel in order to ensure insulation between the parallel terminals. In such a sealing structure, there is a risk that insulation between the main terminal and the cooler cannot be ensured due to voids or unfilled portions in the sealing member.

From the viewpoint described above or from other unmentioned viewpoints, there is a demand for further improvement to the power conversion device.

It is an object of the present disclosure to provide a power conversion device with a high insulation reliability.

A power conversion device according to an exemplar of the present disclosure includes: a base provided with a cooler; a semiconductor module that includes a body portion including a semiconductor element, and a plurality of main terminals including parallel terminals arranged side by side with each other and protruding from the body portion, the semiconductor module being stacked on the cooler; a frame fixed to the base and arranged around the semiconductor module in a plan view of a stacking direction in which the cooler and the semiconductor module are stacked; and a sealing member having an electrically insulation and filled in a region that is surrounded by the frame and seals the main terminal. The frame includes (i) an outer peripheral wall portion that surrounds the semiconductor module in the plan view, and (ii) an extension portion that is made of an electrically insulating material, extends from the outer peripheral wall portion to a position that overlaps with the semiconductor module in the plan view, and is positioned between the semiconductor module and the cooler in the stacking direction.

According to the above disclosed power conversion device, even when a void or an unfilled gap occurs in the sealing member, the extension portion of the frame can increase an along-surface distance between the main terminal and the cooler. As a result, a power conversion device with a high insulation reliability can be provided.

Disclosed embodiments herein employ different technical means to achieve their respective objects. Reference numerals in parentheses described in the Technical idea(s) exemplarily show corresponding relationships with parts of embodiments to be described later, and are not intended to limit technical scopes. The objects, features, and advantages disclosed in the present specification will become apparent by referring to following detailed descriptions and accompanying drawings.

Hereinafter, multiple embodiments will be described with reference to the drawings. The same reference numerals are assigned to the corresponding elements in each embodiment, and thus, duplicate descriptions may be omitted. When only a part of a configuration is described in each embodiment, a configuration of another embodiment described earlier can be applied to the other part of such configuration. Further, it is possible to not only combine configurations as specified in the description of the embodiments, but also partially combine configurations of embodiments even though not specified herein as long as the combination does not cause difficulty.

The power conversion device according to the present embodiment is applicable to, for example, a power conversion device for a moving object in which a rotating electric machine is used as a drive source. Examples of moving objects include electric vehicles such as battery electric vehicles (BEVs), hybrid electric vehicles (HEVs), and plug-in hybrid electric vehicles (PHEVs), electric flying objects such as drones and electric vertical take-off and landing aircraft (eVTOLs), ships, construction machinery, and agricultural machinery. Hereinafter, an example applied to a vehicle will be described.

### First Embodiment

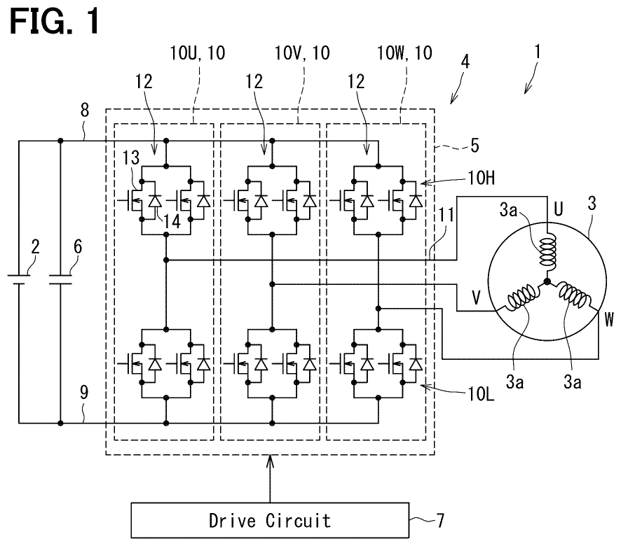

First, a schematic configuration of a vehicle drive system is described based on FIG. 1.

### Vehicle Drive System

As shown in FIG. 1, a vehicle drive system 1 is provided with a DC power supply 2, a motor generator 3, and a power conversion device 4.

The DC power supply 2 is a direct-current voltage source configured as a chargeable/dischargeable secondary battery. The secondary battery is, for example, a lithium ion battery, a nickel-metal hydride battery, an organic radical battery, or the like. The motor generator 3 is a three-phase AC rotating electric machine. The motor generator 3 functions as a vehicle driving power source, i.e., an electric motor. The motor generator 3 functions also as a generator during regeneration. The power conversion device 4 performs electric power conversion between the DC power supply 2 and the motor generator 3.

### Circuit Configuration of Power Conversion Device

FIG. 1 shows a circuit configuration of the power conversion device 4. The power conversion device 4 includes at least a power conversion circuit. The power conversion circuit of the present embodiment is an inverter 5. The power conversion device 4 may further include a smoothing capacitor 6, a drive circuit 7, and the like.

The smoothing capacitor 6 is made to mainly smooth a DC voltage supplied from the DC power supply 2. The smoothing capacitor 6 is connected between a P line 8 which is a power line on a high potential side and an N line 9 which is a power line on a low potential side. The P line 8 is connected to a positive electrode of the DC power supply 2, and the N line 9 is connected to a negative electrode of the DC power supply 2. The positive electrode of the smoothing capacitor 6 is connected to the P line 8 at a position between the DC power supply 2 and the inverter 5. The negative electrode of the smoothing capacitor 6 is connected to the N line 9 at a position between the DC power supply 2 and the inverter 5. The smoothing capacitor 6 is connected in parallel with the DC power supply 2.

The inverter 5 is a DC-AC conversion circuit. The inverter 5 converts a DC voltage into a three-phase AC voltage, and outputs an AC voltage to the motor generator 3 according to switching control by a control circuit (not illustrated). In such manner, the motor generator 3 is driven to generate a predetermined torque. At the time of regenerative braking of the vehicle, the inverter 5 converts the three-phase AC voltage generated by the motor generator 3 by receiving the rotational force from the wheels into a DC voltage according to the switching control by the control circuit, and outputs the DC voltage to the P line 8. In such manner, the inverter 5 performs bi-directional power conversion between the DC power supply 2 and the motor generator 3.

The inverter 5 includes upper and lower arm circuits 10 for each of the three phases. The upper and lower arm circuits 10 may be referred to as legs. Each of the upper and lower arm circuits 10 has an upper arm 10H and a lower arm 10L. The upper arm 10H and the lower arm 10L are connected in series between the P line 8 and the N line 9 with the upper arm 10H on a P line 8 side.

A connection point between the upper arm 10H and the lower arm 10L, i.e., a midpoint of the upper and lower arm circuit 10, is connected to a winding 3a of the corresponding phase in the motor generator 3 via an output line 11. Of the upper and lower arm circuits 10, a U-phase upper and lower arm circuit 10U is connected to a U-phase winding 3a via the output line 11. A V-phase upper and lower arm circuit 10V is connected to a V-phase winding 3a via the output line 11. A W-phase upper and lower arm circuit 10W is connected to a W-phase winding 3a via the output line 11.

The upper and lower arm circuits 10 (10U, 10V, 10W) have a series circuit 12. The upper and lower arm circuits 10 may have one or more series circuits 12. In case of having a plurality of series circuits 12, the series circuits 12 are connected in parallel to each other to form upper and lower arm circuits 10 for one phase. In the present embodiment, each of the upper and lower arm circuits 10 has one series circuit 12. The series circuit 12 is configured by connecting a switching element on an upper arm 10H side and a switching element on a lower arm 10L side in series between the P line 8 and the N line 9.

The number of high-side switching elements and the number of low-side switching elements constituting the series circuit 12 are not particularly limited. The number thereof may be one or more. The series circuit 12 of the present embodiment has two switching elements on the high side and two switching elements on the low side. Two switching elements on the high side are connected in parallel, and two switching elements on the low side are connected in parallel, thereby forming one series circuit 12. That is, each of the six arms 10H, 10L of the upper and lower arm circuits 10 for three phases is composed of two switching elements connected in parallel to each other.

In the present embodiment, an n-channel MOSFET 13 is used as each switching element. MOSFET is an abbreviation for Metal Oxide Semiconductor Field Effect Transistor. The two high-side MOSFETs 13 connected in parallel are turned on and off at the same timing by a common gate drive signal (drive voltage). The two low-side MOSFETs 13 connected in parallel are turned on and off at the same timing by a common gate drive signal (drive voltage).

A freewheeling diode 14 (hereinafter, referred to as FWD 14) is connected in antiparallel to each of the MOSFETs 13. In case of the MOSFET 13, the FWD 14 may be a parasitic diode (body diode) or an external diode. In the upper arm 10H, a drain of the MOSFET 13 is connected to the P line 8. In the lower arm 10L, a source of the MOSFET 13 is connected to the N line 9. The drain of the MOSFET 13 in the upper arm 10H and the drain of the MOSFET 13 in the lower arm 10L are connected to each other. An anode of the FWD 14 is connected to a source of the corresponding MOSFET 13, and a cathode is connected to the drain.

Note that the switching element is not limited to the MOSFET 13. For example, an IGBT may be used. The IGBT is an abbreviation for an insulated gate bipolar transistor. In case of an IGBT, the FWD 14 is also connected in antiparallel.

The drive circuit 7 drives switching elements that constitute the power conversion circuit such as the inverter 5. The drive circuit supplies a drive voltage to a gate of the MOSFET 13 of the corresponding arm based on a drive command of the control circuit. The drive circuit drives the corresponding MOSFET 13 by applying a drive voltage to turn on and off the drive of the corresponding MOSFET 13. The drive circuit may be referred to as a “driver”.

The power conversion device 4 may include a control circuit for the switching element. The control circuit generates a drive command for operating the MOSFET 13, and outputs the drive command to the drive circuit 7. The control circuit generates a drive command based on a torque request input from a high-level ECU (not illustrated) and signals detected by various sensors, for example. ECU is an abbreviation for Electronic Control Unit. The control circuit may be provided within the high-level ECU.

Various sensors include, for example, a current sensor, a rotation angle sensor, and a voltage sensor. The power conversion device 4 may include at least one sensor. The current sensor detects a phase current flowing through the winding 3a of each phase. The rotation angle sensor detects a rotation angle of a rotor of the motor generator 3. The voltage sensor detects a voltage across the smoothing capacitor 6. The control circuit includes, for example, a processor and a memory. The control circuit outputs, for example, a PWM signal as the drive command. PWM is an abbreviation for Pulse Width Modulation.

The power conversion device 4 may include a converter as the power conversion circuit. The converter is a DC-DC conversion circuit that converts a DC voltage, for example, to a DC voltage of a different value. The converter is provided at a position between the DC power supply 2 and the smoothing capacitor 6. The converter is configured to include, for example, a reactor and the above-mentioned upper and lower arm circuit 10. Such a configuration can boost and/or suppress voltage. The power conversion device 4 may include a filter capacitor for removing power supply noise from the DC power supply 2. The filter capacitor is provided at a position between the DC power supply 2 and the converter.

### Structure of Power Conversion Device

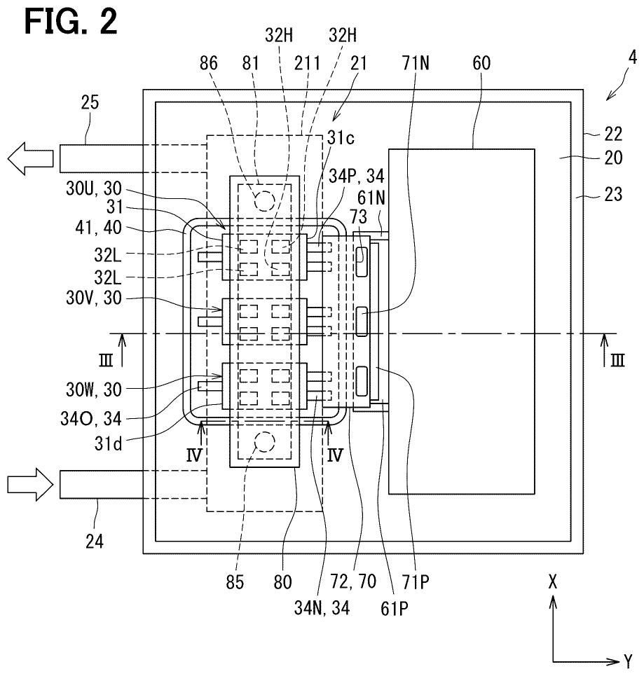

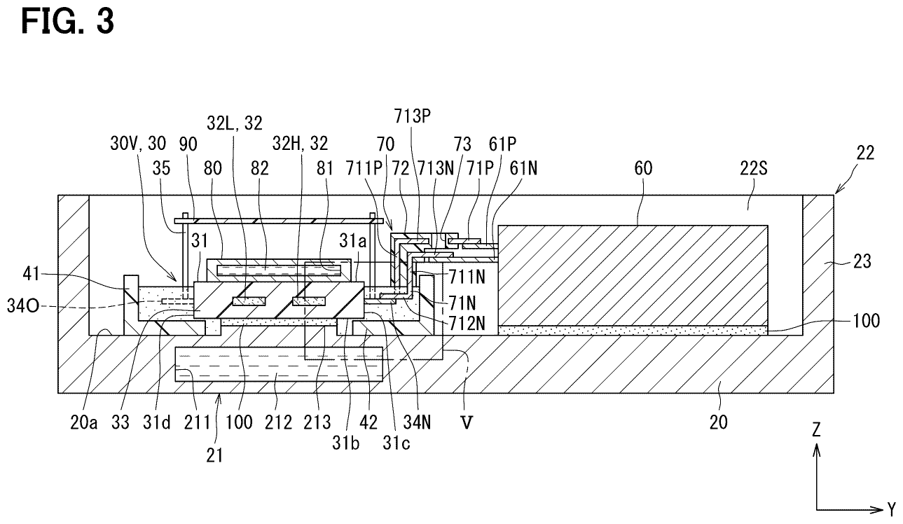

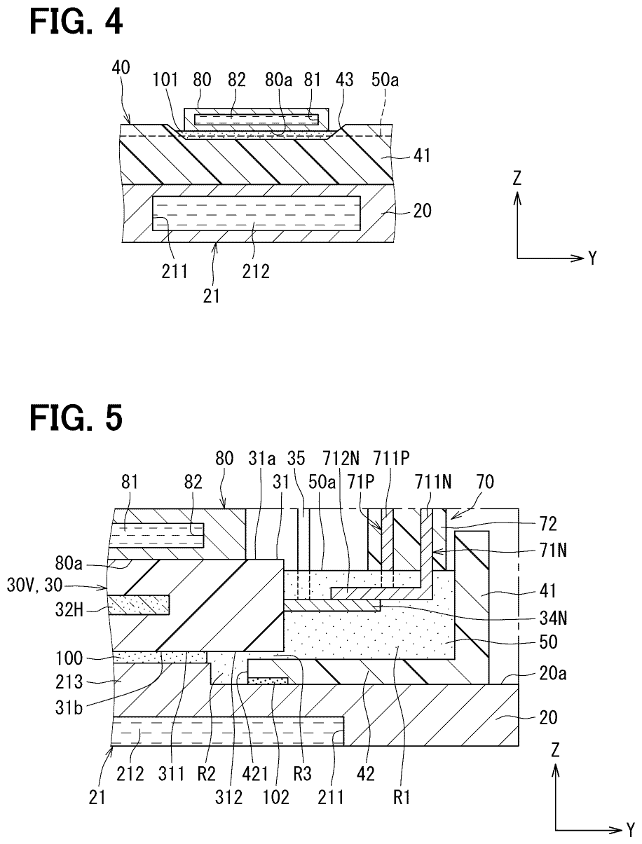

FIG. 2 is a plan view showing the power conversion device 4 of the present embodiment. In FIG. 2, extensions of a frame and a circuit board are omitted so that an arrangement of semiconductor modules and coolers can be seen. White arrows in FIG. 2 indicate a direction in which a refrigerant flows. FIG. 3 is a cross-sectional view taken along a line III-III of FIG. 2. FIG. 4 is a cross-sectional view taken along a line IV-IV of FIG. 2. FIG. 5 is an enlarged view of an area V enclosed by a one-dot chain line shown in FIG. 3.

The power conversion device 4 of the present embodiment includes a base 20 having a first cooler 21, a semiconductor module 30, a frame 40, and a sealing member 50. The power conversion device 4 may further include a capacitor 60 and a bus bar unit 70. The power conversion device 4 may include a second cooler 80. The power conversion device 4 may include a circuit board 90. As an example, the power conversion device 4 of the present embodiment includes a plurality of semiconductor modules 30. The power conversion device 4 also includes the capacitor 60, the bus bar unit 70, the second cooler 80, and the circuit board 90.

In the following description, the direction in which the semiconductor modules 30 are arranged is defined as an X direction. A Z direction is defined as perpendicular to the X direction and is a stacking direction of the semiconductor modules 30 and the first coolers 21. A direction orthogonal to both of the Z direction and the X direction is defined as a Y direction. The X direction, the Y direction, and the Z direction are in a positional relationship orthogonal to each other. A plan view from the Z direction may be simply referred to as a plan view. When describing relative positions of two members, the position of the member closer to the base 20 in the Z direction may be referred to as a lower position, and the position of the member farther from the base 20 may be referred to as an upper position. First, the schematic configuration of each element will be described.

### Base and First Cooler

The base 20 has a semiconductor module 30 mounted on one surface 20a thereof. The base 20 is a support member that supports the semiconductor module 30. As an example, in the present embodiment, the semiconductor module 30 and the capacitor 60 are disposed on one surface of the base 20. The base 20 is made of a metal material such as aluminum.

The base 20 has a first cooler 21. The first cooler 21 is configured by utilizing the base 20. The first cooler 21 is a cooling section in the base 20. The first cooler 21 may be provided with a flow path through which a refrigerant flows, or may be a heat dissipation member provided with a heat sink or heat dissipation fins. As an example, the first cooler 21 of the present embodiment is configured to include a flow path 211 formed inside the base 20 and a surrounding portion of the flow path 211 in the base 20, as shown in FIGS. 2 and 3. A refrigerant 212 flows through the flow path 211. Examples of the refrigerant 212 include a phase-changing refrigerant such as water or ammonia, and a non-phase-changing refrigerant such as ethylene glycol or the like. The first cooler 21 cools the semiconductor module 30 from a rear surface 31b.

The flow path 211 is provided so as to overlap at least a portion of each of the semiconductor modules 30 in a plan view in order to efficiently cool the semiconductor modules 30. As an example, the flow path 211 in the present embodiment is provided so as to enclose most of each of the semiconductor modules 30 in a plan view. The flow path 211 extends along the arrangement direction of the three semiconductor modules 30, that is, along the X direction. The flow path 211 extends in the X direction.

The base 20 having the first cooler 21 may be formed of a single member, or may be formed by combining a plurality of members. The base 20 may be configured, for example, by combining two members, or by combining three members. The base 20 may be configured by combining a plurality of members in one portion and by a single member in the other portion. The first cooler 21 may be formed of a single member, for example, by a die casting method, or may be formed by combining a plurality of members. The base 20 may have a structure in which the first cooler 21, which is formed by combining two members, is locally disposed on a single member, for example. For convenience, the base 20 is illustrated in a simplified manner in FIG. 3.

The surface 20a of the base 20 may be flat or may have projections and recesses. As an example, the first cooler 21 in the present embodiment has a convex portion 213 that supports a body portion 31 of the semiconductor module 30. The convex portion 213 may be provided for each semiconductor module 30 individually, or may be provided for a group of a plurality of semiconductor modules 30. In the present embodiment, one convex portion 213 is provided extending in the X direction so as to support the body portions 31 of the three semiconductor modules 30. For convenience, a portion other than the convex portion 213 is shown as flat in FIG. 3.

The base 20 may be provided as a standalone base 20 or may be provided as part of a case that houses other elements of the power conversion device 4. As an example, the base 20 in the present embodiment is provided as a bottom wall of a case 22. The case 22 has an opening to accommodate other elements. The case 22 has the base 20 forming a bottom wall, and a side wall 23 that is connected to the base 20 and defines a housing space 22S together with the base 20. As an example, the case 22 in the present embodiment has a box shape with one side open. The case 22 has a substantially rectangular shape when viewed in a plan view in the Z direction. Arranged in the housing space 22S of the case 22 are the semiconductor module 30, the frame 40, the sealing member 50, the capacitor 60, the bus bar unit 70, the second cooler 80, the circuit board 90, and the like.

An inlet pipe 24 for supplying refrigerant to the first cooler 21 and the second cooler 80, and an outlet pipe 25 for discharging the refrigerant from the first cooler 21 and the second cooler 80 are attached to the side wall 23. The inlet pipe 24 and the outlet pipe 25 are inserted through corresponding through holes (not shown), and are arranged from the inside to the outside of the case 22. Each of the inlet pipe 24 and the outlet pipe 25 includes a portion extending in the Y direction. The inlet pipe 24 and the outlet pipe 25 are attached to a common side wall 23 (i.e., the same side wall), for example.

The power conversion device 4 may include a cover (lid) (not shown) that closes the opening of the case 22. The case 22 and the cover may be referred to as a housing member. The base 20 may have a cooler that cools the capacitor 60. The base 20 may have a flow path separate from the flow path 211 for cooling the capacitor 60. The other flow path is provided so as to overlap at least a portion of the capacitor 60 in a plan view. The flow path 211 may be expanded so as to overlap at least a portion of the capacitor 60 in a plan view.

### Semiconductor Module

The semiconductor module 30 constitutes the upper and lower arm circuits 10 described above, that is, the inverter 5. The power conversion device 4 of the present embodiment includes three semiconductor modules 30. One semiconductor module 30 provides one series circuit 12, that is, the upper and lower arm circuits 10 for one phase. The plurality of semiconductor modules 30 include the semiconductor module 30U constituting the upper and lower arm circuits 10U, the semiconductor module 30V constituting the upper and lower arm circuits 10V, and the semiconductor module 30W constituting the upper and lower arm circuits 10W.

All the semiconductor modules 30 have a common structure. Each semiconductor module 30 includes the body portion 31 and external connection terminals protruding from the body portion 31. The body portion 31 includes a semiconductor element 32, a sealing body 33, and the like.

The semiconductor element 32 includes a switching element formed on a semiconductor substrate which is made of a material such as silicon (Si), a wide bandgap semiconductor having a wider bandgap than silicon, or the like. The switching element has a vertical structure so that a main current flows in the thickness direction of the semiconductor substrate. Examples of the wide bandgap semiconductor include silicon carbide (SiC), gallium nitride (GaN), gallium oxide (Ga2O3) and diamond. The semiconductor element 32 may be referred to as a power element, a semiconductor chip or the like.

The semiconductor element 32 of the present embodiment is configured by forming the above-mentioned n-channel MOSFET 13 and FWD 14 on a semiconductor substrate made of SiC. The MOSFET 13 has a vertical structure so that a main current flows in the thickness direction of a semiconductor element 32 (semiconductor substrate). The semiconductor element 32Has main electrodes (not shown) on both sides in the thickness direction of the semiconductor element 32. Specifically, as main electrodes of the switching element, a source electrode is provided on a front surface, and a drain electrode is provided on a back surface. The source electrode is formed on a portion of the front surface. The drain electrode is formed over almost an entire back surface.

The main current flows between the drain and source electrodes. The semiconductor element 32Has a pad (not shown) which is an electrode for signals on a surface on which the source electrode is formed. The semiconductor element 32 is arranged so that its thickness direction is substantially parallel to the Z direction. The semiconductor element 32 of the present embodiment includes two semiconductor elements 32H that provide switching elements on the high side of the series circuit 12 and two semiconductor elements 32L that provide switching elements on the low side of the series circuit 12. The semiconductor elements 32H and 32L are arranged side by side in the Y direction. The two semiconductor elements 32H are arranged side by side in the X direction. Similarly, the two semiconductor elements 32L are arranged side by side in the X direction.

The four semiconductor elements 32 provide the four switching elements of one series circuit 12. The semiconductor module 30 includes the semiconductor elements 32 whose number corresponds to the number of switching elements that constitute one series circuit 12. When the series circuit 12 includes two switching elements, the semiconductor module 30 includes one semiconductor element 32H and one semiconductor element 32L.

The sealing body 33 seals a part of other elements constituting the semiconductor modules 30. The other parts of the other elements are exposed to the outside of the sealing body 33. The sealing body 33 seals the semiconductor element 32, a part of each of the external connection terminals, and the like. The other portion of each of the external connection terminals protrudes to an outside of the sealing body 33. The sealing body 33 is made of, for example, resin as a material. The sealing body 33 is molded by, for example, a transfer molding method using epoxy resin as a material. The sealing body 33 has, for example, a substantially rectangular shape in a plan view. The sealing body 33 forms an outer shell of the body portion 31.

The sealing body 33, i.e., the body portion 31, has one surface 31a as a surface forming an outer shell, and a back surface 31b that is a surface opposite to the one surface 31a in the Z direction. The one surface 31a and the back surface 31b are, for example, flat surfaces. Further, side surfaces 31c and 31d that connect the one surface 31a and the back surface 31b are provided. The side surface 31c is a surface opposite to the side surface 31d in the Y direction.

The external connection terminals include a main terminal 34 and a signal terminal 35. The main terminal 34 is an external connection terminal electrically connected to the main electrodes of the semiconductor element 32. The main terminal 34 include a P terminal 34P, an N terminal 34N, and an output terminal 34O. The P terminal 34P is electrically connected to a drain electrode of the semiconductor element 32H. The N terminal 34N is electrically connected to a source electrode of the semiconductor element 32L. The P terminal 34P may be referred to as a high potential power supply terminal, a positive terminal, or the like. The N terminal 34N may be referred to as a low potential power supply terminal, a negative terminal, or the like. The P terminal 34P and the N terminal 34N protrude outward from the side surface 31c of the body portion 31. The protruding portions of the P terminal 34P and the N terminal 34N are arranged side by side in the X direction. In other words, the P terminal 34P and the N terminal 34N correspond to parallel terminals.

The output terminal 34O is electrically connected to a connection point between the source electrode of the semiconductor element 32H and the drain electrode of the semiconductor element 32L, that is, the connection point (midpoint) of the series circuit 12. The output terminal 34O protrudes from the side surface 31d of the body portion 31 to the outside. The output terminal 34O may be referred to as an O terminal, an AC terminal, or the like. The output terminal 34O is connected to a corresponding winding 3a of the motor generator 3, for example, via a bus bar (not shown). A connection portion of the bus bar with the output terminal 34O can be sealed with a sealing body 33.

The signal terminal 35 is an external connection terminal electrically connected to a pad of the semiconductor element 32. The signal terminal 35 protrudes to the outside from the body portion 31 (sealing body 33). For example, a signal terminal 35 connected to a pad of the semiconductor element 32H protrudes from the side surface 32c of the sealing body 33. The signal terminal 35 connected to the pad of the semiconductor element 32L protrudes from the side surface 32d of the sealing body 33. The protruding portion of the signal terminal 35 has a bent portion, and extends upward.

In addition to the above-mentioned elements, the semiconductor module 30 also includes a wiring member (not shown). The wiring member provides a wiring function for electrically connecting the main electrodes of the semiconductor element 32 and the main terminal 34. The wiring member provides a heat dissipation function for dissipating heat from the semiconductor element 32. The wiring member is arranged, for example, in the Z direction so as to sandwich the semiconductor element 32 therebetween. The wiring member may be, for example, a substrate having metal bodies disposed on both sides of an insulating base material, or may be a heat sink which is a metal member. The heat sink may be provided as part of a lead frame. The wiring member may be entirely sealed by the sealing body 33, or may be partially exposed from at least one of the one surface 31a and the back surface 31b of the body portion 31. As an example, in the present embodiment, a surface of one of the wiring members opposite to the semiconductor element 32 is exposed from the one surface 31a, and a surface of the other wiring member opposite to the semiconductor element 32 is exposed from the back surface 31b. In such manner, heat radiation capacity is improvable.

The semiconductor module 30 described above is disposed on the first cooler 21 so that the back surface 31b faces the one surface 20a of the base 20. A thermally conductive member may be disposed at a position between the semiconductor module 30 and the first cooler 21. As an example, in the present embodiment, a thermally conductive member 100 is interposed between the semiconductor module 30 and the first cooler 21. The thermally conductive member 100 transfers heat from the semiconductor module 30, e.g., heat generated by the semiconductor element 32, to the first cooler 21. The thermally conductive member 100 has electrical insulation properties. As an example, the thermally conductive member 100 in the present embodiment is a heat conductive grease. A heat conductive gel may be used instead of the heat conductive grease. The thermally conductive member 100 may be referred to as a TIM. The TIM is an abbreviation for Thermal Interface Material. The thermally conductive member 100 is a member that can flow in association with the expansion and contraction of the semiconductor module 30 in the Z direction.

As shown in FIG. 2, the three semiconductor modules 30 are aligned in the X direction. In other words, the multiple semiconductor modules 30 are arranged side by side along the X direction. As an example, in the present embodiment, the three semiconductor modules 30 are arranged in this order of semiconductor module 30U, semiconductor module 30V, and semiconductor module 30W. Further, in the X direction, the side surfaces of adjacent semiconductor modules 30 face each other with a predetermined gap interposed therebetween. Specifically, a side surface of the semiconductor module 30U faces a side surface of the semiconductor module 30V. A side surface of the semiconductor module 30V faces a side surface of the semiconductor module 30W.

### Frame

The frame 40 is disposed on the one surface 20a of the base 20, and defines a filling area for the sealing member 50. The frame 40 is disposed so as to surround the semiconductor module 30 in a plan view in the Z direction. The frame 40 has an annular shape in a plan view. The frame 40 may be provided for each semiconductor module 30 individually, or may be provided so as to surround all of the semiconductor modules 30 included in the power conversion device 4. As an example, the frame 40 of the present embodiment is disposed so as to surround three semiconductor modules 30. The frame 40 is fixed to the base 20. The frame 40 will be described in detail later.

The frame 40 may preferably be disposed inside an outer circumferential end of the first cooler 21 when viewed in a plan view in the Z direction. For example, in case of having the base 20 in which the first cooler 21 formed by combining two components is locally arranged on a single member, it is preferable to provide the frame 40 so that the outer circumferential end of an outer circumferential wall portion 41 is positioned inside the outer circumferential end of the first cooler 21 when seen in a plan view. In such manner, the frame 40 is made smaller in size in a direction perpendicular to the Z direction. Further, an amount of the sealing member 50 used is reducible.

### Sealing Member

The sealing member 50 has electrical insulation properties. The sealing member 50 fills the area surrounded by the frame 40. The sealing member 50 seals the main terminal 34 of the semiconductor module 30. The sealing member 50 seals the protruding portions of the P terminal 34P and the N terminal 34N in order to ensure insulation between the above-mentioned parallel terminals, that is, the P terminal 34P and the N terminal 34N. When designating the above-mentioned sealing body 33 as a primary sealing member, the sealing member 50 is a secondary sealing member. A portion of each of the main terminals 34 is sealed by the sealing body 33, and a portion protruding from the sealing body 33 is sealed by the sealing member 50.

As an example, the sealing member 50 in the present embodiment is a gel. For example, silicone gel can be used. Instead of using a gel, a resin, for example a potting resin, may be used. The sealing member 50 also seals a portion of a P bus bar 71P and a portion of an N bus bar 71N provided in the bus bar unit 70.

### Capacitor

The capacitor 60 is served as the smoothing capacitor 6 described above. The capacitor 60 includes, for example, a case (not shown) and a capacitor element housed in the case. In FIGS. 2 and 3, the capacitor 60 is illustrated in a simplified manner.

As an example, the capacitor element of the present embodiment is a film capacitor element. The capacitor element is formed, for example, by winding a film around an axis in the Z direction. The capacitor element has electrodes (not shown) on both end surfaces in the Z direction. The electrodes are sometimes referred to as a metal connector or an electrical connector. The capacitor 60 includes a P bus bar 61P connected to the positive electrode, and an N bus bar 61N connected to the negative electrode.

The P bus bar 61P and the N bus bar 61N are plate-shaped metal members. The P bus bar 61P and the N bus bar 61N are connected to the corresponding electrodes by soldering, resistance welding, laser welding, or the like. In FIGS. 2 and 3, terminal portions of the P bus bar 61P and the N bus bar 61N for connection to the corresponding main terminals 34P, 34N are shown. The P bus bar 61P and the N bus bar 61N have terminal portions (not shown) for electrically connecting the smoothing capacitor 6 and the DC power supply 2.

The capacitor 60 is disposed on the one surface 20a of the base 20 that constitutes the first cooler 21. The capacitor 60 of the present embodiment is disposed in the housing space 22S of the case 22. The capacitor 60 is arranged side by side in the Y direction with respect to the semiconductor module 30. The capacitor 60 has a generally rectangular shape in a plan view with its longitudinal direction aligned in the X direction.

A terminal portion of the P bus bar 61P and a terminal portion of the N bus bar 61N are extended toward the semiconductor module 30 in the Y direction. The terminal portion of the P bus bar 61P and the terminal portion of the N bus bar 61N are arranged so that their plate surfaces face each other in order to reduce inductance. The terminal portion of the P bus bar 61P and the terminal portion of the N bus bar 61N have different extension lengths in the Y direction so as to enable connection to the bus bar unit 70. As an example, in the present embodiment, the terminal portion of the N bus bar 61N is positioned below the terminal portion of the P bus bar 61P. The terminal portion of the N bus bar 61N is longer in the Y direction than the terminal portion of the P bus bar 61P.

### Bus Bar Unit

The bus bar unit 70 is a wiring member that electrically connects the semiconductor module 30 and the capacitor 60. The bus bar unit 70 is formed by integrally holding plate-shaped metal members that provide wiring functions with an insulating member. As shown in FIGS. 2 and 3, the bus bar unit 70 includes a P bus bar 71P, an N bus bar 71N, and an insulating member 72.

The insulating member 72 holds the P bus bar 71P and the N bus bar 71N in a predetermined positional relationship. The insulating member 72 ensures insulation between the P bus bar 71P and the N bus bar 71N. The insulating member 72 is, for example, a resin molded body integrally molded with the P bus bar 71P and the N bus bar 71N. Alternatively, the P bus bar 71P and the N bus bar 71N may be attached to the molded insulating member 72.

The P bus bar 71P and the N bus bar 71N are arranged so that their plate surfaces face each other over most of their entire length in order to reduce inductance. The P bus bar 71P electrically connects the P terminal 34P of the semiconductor module 30 and the P bus bar 61P of the capacitor 60. The N bus bar 71N electrically connects the N terminal 34N of the semiconductor module 30 and the N bus bar 61N of the capacitor 60.

As an example, the P bus bar 71P in the present embodiment has a base portion 711P extending in the Z direction, and extension portions 712P and 713P extending in the Y direction from both ends of the base portion 711P. For convenience, the extension portion 712P is not shown in the drawing, but has the same configuration as the extension portion 712N described below. A large portion of the base portion 711P is held by the insulating member 72. A portion of the base portion 711P protrudes from the insulating member 72 and is sealed by the sealing member 50. The extension portion 712P extends in the Y direction from a lower end of the base portion 711P toward the semiconductor module 30. The extension portion 712P is connected to the P terminal 34P. The protruding portion of the P terminal 34P and the extension portion 712P are sealed with the sealing member 50. The extension portion 713P extends in the Y direction from an upper end of the base portion 711P toward the capacitor 60. The extension portion 713P is connected to the P bus bar 61P.

As an example, the N bus bar 71N of the present embodiment, like the P bus bar 71P, has a base portion 711N extending in the Z direction and extension portions 712N, 713N extending in the Y direction from both ends of the base portion 711N. A large portion of the base portion 711N is held by the insulating member 72. A portion of the base portion 711N protrudes from the insulating member 72 and is sealed by the sealing member 50. The extension portion 712N extends in the Y direction from a lower end of the base portion 711N toward the semiconductor module 30. The extension portion 712N is connected to the N terminal 34N. The protruding portion of the N terminal 34N and the extension portion 712N are sealed with the sealing member 50. The extension portion 713N extends in the Y direction from an upper end of the base portion 711N toward the capacitor 60. The extension portion 713N is connected to the P bus bar 61N.

The P bus bar 71P and the N bus bar 71N can be connected to the corresponding main terminals 43P, 43N and the bus bars 61P, 61N by soldering, resistance welding, laser welding, or the like. As an example, in the present embodiment, the P bus bar 71P and the N bus bar 71N are connected to the corresponding P bus bar 61P and N bus bar 61N by laser welding. For allowing laser welding, the insulating member 72 has a through hole 73. The through hole 73 is an opening provided for laser welding the extension portion 713N, which is a lower layer. The upper layer extension portion 713P is disposed so as to avoid the through hole 73. The number of through holes 73 may be one or more. As an example, the insulating member 72 in the present embodiment has three through holes 73. The three through holes 73 are provided at a predetermined pitch in the X direction as shown in FIG. 2.

### Second Cooler

The second cooler 80 is provided without reusing the base 20 (case 22). The second cooler 80 is disposed on the one surface 31a of the semiconductor module 30. If necessary, a thermally conductive member having electrical insulation properties is disposed at a position between the second cooler 80 and the semiconductor module 30. The second cooler 80 cools the semiconductor module 30 from a side opposite to the first cooler 21 in the Z direction. The second cooler 80 and the first cooler 21 can cool the semiconductor module 30 from both sides in the Z direction.

The second cooler 80 has a flow path 81 disposed therein. As an example, in the present embodiment, a refrigerant 82 is supplied to the flow path 81 via the inlet pipe 24. The refrigerant 82 that has flowed through the flow path 81 is discharged to the outside of the power conversion device 4 via the outlet pipe 25. The second cooler 80 is disposed in the housing space 22S of the case 22. The refrigerant 82 is the same as the refrigerant 212 described above.

In the Z direction, the second cooler 80 is thinner than the first cooler 21. The second cooler 80 is, for example, a tubular body having a flattened shape as a whole. The second cooler 80 is configured to have the flow path 81 disposed therein, using, for example, a pair of plates (thin metal plates). At least one of the pair of plates is pressed into a shape that bulges in the Z direction. Thereafter, outer peripheral edges of the pair of plates are fixed to each other by caulking or the like, and are joined to each other on the entire circumference by brazing or the like. As a result, the flow path 81 through which the refrigerant 82 can flow is formed between the pair of plates.

The flow paths 81 are provided so as to overlap at least a portion of each of the semiconductor modules 30 in a plan view in order to efficiently cool the semiconductor modules 30. The flow path 81 in the present embodiment is provided so as to overlap most of each of the semiconductor modules 30 in a plan view. The flow path 81 extends along the direction in which the three semiconductor modules 30 are arranged, that is, along the X direction. The flow path 81 extends in the X direction. The flow path 81 extends across the three semiconductor modules 30 in the X direction. In a plan view, the flow path 81 is contained within the flow path 211. The extension length of the flow path 81 is shorter than the extension length of the flow path 211.

The second cooler 80 is stacked on the first cooler 21 with the semiconductor module 30 interposed therebetween. The second cooler 80 may be pressed in the Z direction from the surface opposite to the semiconductor module 30 by a pressing member (not shown). By applying pressure, good thermal conduction is maintained between the second cooler 80 and the semiconductor module 30, and between the semiconductor module 30 and the first cooler 21, respectively. The pressing member may include, for example, a pressure plate and an elastic member. The elastic member is, for example, a material that generates a pressing force by elastic deformation of rubber, or a metal spring. The elastic member is disposed at a position between the pressure plate and the second cooler 80 in the Z direction. By fixing the pressure plate at a predetermined position relative to the case 22, the elastic member is elastically deformed. A reaction force of the elastic deformation presses the second cooler 80 and the semiconductor module 30 against the first cooler 21 (base 20).

The second cooler 80 is connected to the first cooler 21 via connecting pipes 85 and 86. The connecting pipe 85 is connected to the vicinity of one end of the second cooler 80 in the X direction, specifically, to the vicinity of an end portion closer to the inlet pipe 24. The connecting pipe 86 is connected to the vicinity of the other end of the second cooler 80, specifically, to the vicinity of an end portion closer to the outlet pipe 25. The two connecting pipes 85 and 86 are disposed in the X direction between the connecting position of the inlet pipe 24 and the first cooler 21 and the connecting position of the outlet pipe 25 and the first cooler 21.

A portion of the refrigerant supplied from the inlet pipe 24 flows through the flow path 211 as the refrigerant 212, and is discharged from the outlet pipe 25. Other portion of the refrigerant is supplied to the flow path 81 through the flow path 211 and the flow path of the connecting pipe 85. The refrigerant 82 that has flowed through the flow path 81 flows into the flow path 211 through the flow path of the connecting pipe 86, and is discharged from the outlet pipe 25. The flow rate of the refrigerant 212 flowing through the flow path 211 is greater than the flow rate of the refrigerant 82 flowing through the flow path 81. The flow path 211 is a main flow path, and the flow path 81 is a sub-flow path branched off from the flow path 211.

### Circuit Board

Although not shown, the circuit board 90 includes a wiring board in which wiring is arranged on an insulating base material such as resin, electronic components mounted on the wiring board, connectors, and the like. The circuit is composed of mounted electronic components and wiring. The above-described drive circuit 7 is configured on the circuit board 90.

The circuit board 90 is arranged so as to overlap the semiconductor module 30 in a plan view in the Z direction. The circuit board 90 is arranged above the three semiconductor modules 30. The signal terminals 35 of the three semiconductor modules 30 are mounted on the circuit board 90. As an example, the circuit board 90 in the present embodiment is arranged in the housing space 22S of the case 22. The circuit board 90 is positioned above the second cooler 80.

### Structural Details of the Frame and Arrangement of Sealing Members

As shown in FIGS. 2, 3 and 5, the frame 40 has an outer circumferential wall portion 41 and an extension portion 42. The outer circumferential wall portion 41 surrounds the semiconductor module 30 in a plan view. The outer circumferential wall portion 41 has an annular shape in a plan view. The extension portion 42 is connected to the outer circumferential wall portion 41 and extends inward from the outer circumferential wall portion 41, i.e., toward the body portion 31. As an example, the outer circumferential wall portion 41 in the present embodiment extends in the Z direction. The extension portion 42 extends from a lower end of the outer circumferential wall portion 41 in a direction perpendicular to the Z direction.

Of the frame 40, at least the extension portion 42 is formed using an electrically insulating material such as resin. The entire frame 40 may be formed using an electrically insulating material, or a part of the frame 40 may include a metal portion formed by insert molding or the like. As an example, the frame 40 of the present embodiment is a resin molded body, and is entirely made of resin.

The outer circumferential wall portion 41 surrounds the three semiconductor modules 30 in a plan view. The outer circumferential wall portion 41 extends across the second cooler 80 in the Y direction. An upper end of the outer circumferential wall portion 41 is positioned below the lower surface 80a of the second cooler 80 in a portion that extends across the second cooler 80, and is positioned above the lower surface 80a in the other portion. As shown in FIG. 4, the outer circumferential wall portion 41 has, provided therein, a recess 43 including a portion facing the second cooler 80, that is, a portion overlapping with the second cooler 80 in a plan view. The recess 43 is provided so as to avoid contact with the second cooler 80.

Further, a filler member 101 is arranged so as to fill a gap between a wall surface of the recess 43 and the second cooler 80. The filler member 101 is arranged on the wall surface of the recess 43 up to the same level as the lower surface 80a of the second cooler 80. The filler member 101 is formed, for example, using a material that can prevent leakage of the pre-hardened sealing member 50. As an example, the filler member 101 in the present embodiment is an adhesive material. The filler member 101 is sometimes referred to as a sealing material.

A portion of the extension portion 42 overlaps with the semiconductor module 30 in a plan view. The extension portion 42 extends into a position between the semiconductor module 30 and the first cooler 21 in the Z direction. The extension portion 42 are arranged so as to overlap at least the protruding portions of the main terminals 34. The extension portion 42 is provided so as to overlap the protruding portion of the main terminal 34 and the surrounding portion thereof. The extension portion 42 includes a portion of the outer circumferential wall portion 41 that extends in the Y direction from a portion whose longitudinal direction is in the X direction. The extension portion 42 may be provided so as to integrally enclose the protruding portions of the main terminals 34. The extension portion 42 may be provided in an annular shape so as to surround the multiple semiconductor elements 32. As an example, the extension portion 42 in the present embodiment has an annular shape in a plan view.

The extension portion 42 may extend into a position between the semiconductor module 30 and the first cooler 21 in the Z direction. A portion of the extension portion 42 may be arranged to overlap the body portion 31 in a plan view. As an example, the extension portion 42 in the present embodiment extends to a position that overlaps with an end region 312 of the body portion 31 in a plan view.

The extension portion 42 may be in contact with the first cooler 21 and/or the body portion 31. More preferably, the extension portion 42 is adhesively fixed to the first cooler 21 and/or the body portion 31. As an example, the extension portion 42 in the present embodiment is fixed to the first cooler 21 (to the one surface 20a) via an adhesive 102. As shown in FIG. 5, a portion of the extension portion 42 near a tip thereof, which overlaps with the end region 312 in a plan view, is adhesively fixed to the periphery of the convex portion 213 of the first cooler 21. The adhesive 102 is provided in an annular shape so as to surround the semiconductor elements 32 of the three semiconductor modules 30 in a plan view. The adhesive 102 is provided in an annular shape so as to surround the convex portion 213 in a plan view.

The frame 40 of the present embodiment provides three regions R1, R2, and R3 as regions (spaces) in which the sealing member 50 is arranged. The region R1 is defined to include the outer circumferential wall portion 41, the extension portion 42, and the side surface of the body portion 31, and is a region in which the protruding portion of the main terminal 34 is arranged. The region R1 may be defined to further include the first cooler 21 (base 20). The region R2 is a region defined to include a tip 421 (an end surface) of the extension portion 42, the end region 312 of the body portion 31, and the first cooler 21. The first cooler 21 includes the side surface of the convex portion 213 and the surrounding area of the convex portion 213 as portions that define the region R2. The region R2 has a smaller volume than the region R1. The region R3 is positioned between the regions R1 and R2, and is a communicating region that communicates with the regions R1 and R2. The region R1 corresponds to a first region, the region R2 corresponds to a second region, and the region R3 corresponds to a third region.

As described above, the extension portion 42 in the present embodiment is adhesively fixed only to the first cooler 21, and the region R2 is the region where the end region 312 of the body portion 31 and the extension portion 42 face each other. As shown in FIG. 5, the sealing member 50 is arranged continuously in three regions R1, R2, and R3. The sealing member 50 (gel) arranged in the region R3 is continuous with the sealing members 50 arranged in the regions R1 and R2.

The protruding portion of the main terminal 34 and the extension portions 712P, 712N connected to the protruding portion are positioned below the lower surface 80a of the second cooler 80. A surface 50a of the sealing member 50 is also positioned lower than the lower surface 80a of the second cooler 80. The surface 50a is positioned above the protruding portion of the main terminal 34 and the extension portions 712P, 712N. As an example, the surface 50a in the present embodiment is positioned between a bottom surface of the wall of the recess 43 and the lower surface 80a of the second cooler 80, as indicated by the dashed line in FIG. A filler member 101 is disposed in the opposing region between the wall surface of the recess 43 and the lower surface 80a, up to a position higher than the front surface 50a.

### Summary of First Embodiment

According to the power conversion device 4 of the present embodiment, the protruding portions of the main terminals 34 are sealed by the sealing member 50 arranged within the frame 40. The sealing member 50 also seals the protruding portions of the P terminal 34P and N terminal 34N, which are parallel terminals. In such manner, the gap between the parallel terminals is reducible to reduce the wiring inductance, while ensuring insulation between the parallel terminals by the sealing member 50.

Further, the frame 40 is made of an electrically insulating material, and has the extension portion 42 that extends from the outer circumferential wall portion 41 to a position that overlaps with the semiconductor module 30 in a plan view. The extension portion 42 is inserted into a position between the semiconductor module 30 and the first cooler 21 (cooler) in the Z direction.

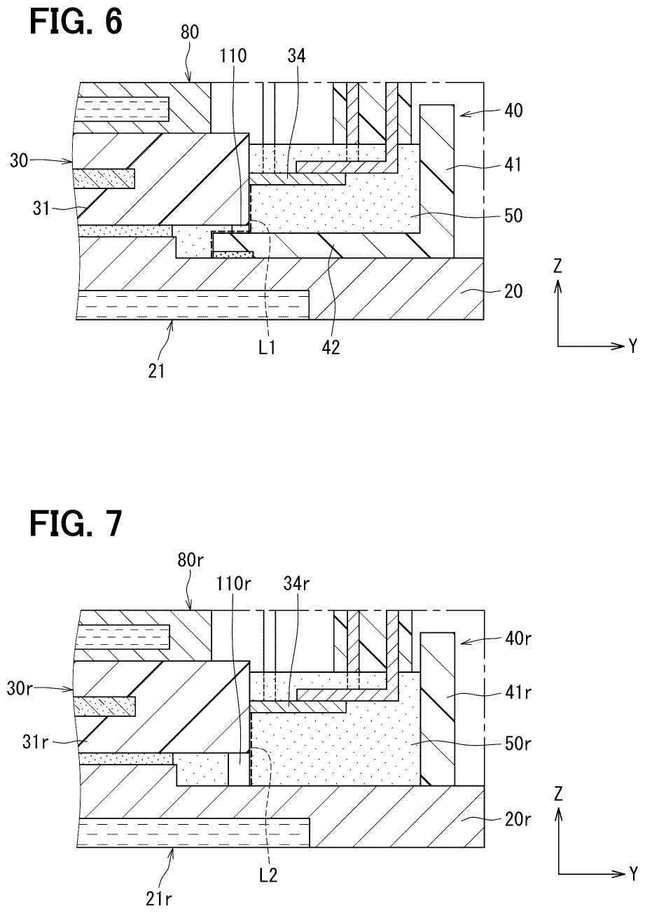

Therefore, as shown in FIG. 6, even when a gap 110 such as a void or an unfilled space occurs in the sealing member 50 directly below the semiconductor module 30, the extension portion 42 of the frame 40 can lengthen an along-surface distance L1 between the main terminal 34 and the first cooler 21. As an example, FIG. 6 shows an example in which the gap 110 occurs directly below the body portion 31. FIG. 7 is a diagram showing a comparative example. In the comparative example, a character “r” is added to the end of the reference numerals of related elements in the present embodiment. In the comparative example, a frame 40r does not have an extension portion. Therefore, when a gap 110r occurs in a sealing member 50r, an along-surface distance L2 between a main terminal 34r and a first cooler 21r is determined along a surface of the sealing member 50r that defines the gap 110r. Therefore, the along-surface distance L2 is short. The along-surface distance L2 is shorter than the along-surface distance L1. In order to increase the along-surface distance L2, that is, to ensure the required insulation performance, it is necessary to separate the main terminal 34r and the first cooler 21r farther away from each other in the Z direction, which increases a physical size in the Z direction. Note that FIGS. 6 and 7 correspond to FIG. 5.

As described above, according to the present embodiment, it is possible to provide the power conversion device 4 with high insulation reliability. According to the present embodiment, it is possible to improve insulation reliability while suppressing an increase in size in the Z direction. Further, an amount of the sealing member 50 used is reducible.

As an example, in the present embodiment, the first cooler 21 has the convex portion 213, and the extension portion 42 extends into a position between the body portion 31 and a periphery of the convex portion of the first cooler 21. The extension portion 42 is positioned so as to overlap the end region 312 of the body portion 31. Therefore, even when the gap 110 occurs directly below the body portion 31 as shown in FIG. 6, the along-surface distance L1 can be made longer. That is, the insulation reliability is further improvable.

As an example, the extension portion 42 in the present embodiment is in contact with the first cooler 21. According to the above, when filling the area surrounded by the frame 40 with the sealing member 50, leakage of the sealing member 50 from the gap between the extension portion 42 and the first cooler 21 is suppressible. In particular, in the present embodiment, the extension portion 42 is adhesively fixed to the first cooler 21. Therefore, the effect of suppressing leakage from the sealing member 50 is improvable.

As an example, in the present embodiment, the thermally conductive member 100 is interposed between the convex portion 213 of the first cooler 21 and the body portion 31 of the semiconductor module 30. Further, the sealing member 50 is arranged continuously in the three regions R1 (first region), R2 (second region), and R3 (third region) defined by including the frame 40. The region R1 is defined to include the outer circumferential wall portion 41, the extension portion 42, and the side surface of the body portion 31, and is a region in which the protruding portion of the main terminal 34 is arranged. The region R2 is a region defined to include the tip 421 of the extension portion 42, the end region 312 of the body portion 31, and the first cooler 21. The region R3 is positioned between the regions R1 and R2, and is a communicating region that communicates with the regions R1 and R2.

During filling, the gel that is the sealing member 50 is filled from the region R1 through the region R3 into the region R2. The sealing member 50 in a hardened state fills the region R2. Therefore, it is possible to suppress the thermally conductive member 100, for example, thermal conductive grease, from being pushed out into the region R2, which is the space outside its intended region, due to thermal expansion or contraction in the Z direction of the semiconductor module 30 (body portion 31). In other words, pump-out is suppressible.

As an example, in the present embodiment, the outer circumferential wall portion 41 of the frame 40 is arranged to extend, at a position closer to the base 20 than the second cooler 80, across the second cooler 80 in a plan view. The surface 50a of the sealing member 50 is positioned closer to the first cooler 21 in the Z direction than the lower surface 80a of the second cooler 80. In a configuration in which the outer circumferential wall portion 41 extends across the second cooler 80, the upper end of the outer circumferential wall portion 41 directly below the second cooler 80 is lower than the lower surface 80a. In contrast, since the sealing member 50 is filled so that the surface 50a is positioned lower than the lower surface 80a, the sealing member 50 is suppressed from climbing over the outer circumferential wall portion 41 from a portion directly below the second cooler 80 and from leaking to the outside.

In particular, in the present embodiment, the outer circumferential wall portion 41 has the recess 43 in a portion facing the second cooler 80. Further, the filler member 101 is arranged so as to fill the gap between the wall surface of the recess 43 and the second cooler 80. Therefore, leakage of the sealing member 50 from the portion directly below the second cooler 80 to the outside is more efficiently suppressible.

### Modification

The structure of the frame 40 is not limited to the example described above. For example, a frame 40 having a mortar-shaped inclined surface may be used. In the frame 40, a portion including a predetermined range from the upper end of the inclined surface corresponds to the outer circumferential wall portion 41, and a portion including the lower end side of the inclined surface corresponds to the extension portion 42.

Although an example has been shown in which the extension portion 42 is adhesively fixed to the first cooler 21 (base 20), that is, in which the extension portion 42 contacts the first cooler 21 via the adhesive 102, the present disclosure is not limited to such a structure. The extension portion 42 may be in direct contact with the first cooler 21 without the adhesive 102 interposed therebetween. The above-described contact can suppress leakage of the sealing member 50. The lower end of the outer circumferential wall portion 41 of the frame 40 may be fixed to the base 20.

### Second Embodiment

The present embodiment is a modification of preceding embodiment as a basic configuration and may incorporate description of the preceding embodiment. In the preceding embodiment, the extension portion is in contact with the first cooler. Alternatively, an extension portion may be in contact with a body portion of a semiconductor module. Further, the extension portion may be in contact with both of the first cooler and the body portion.

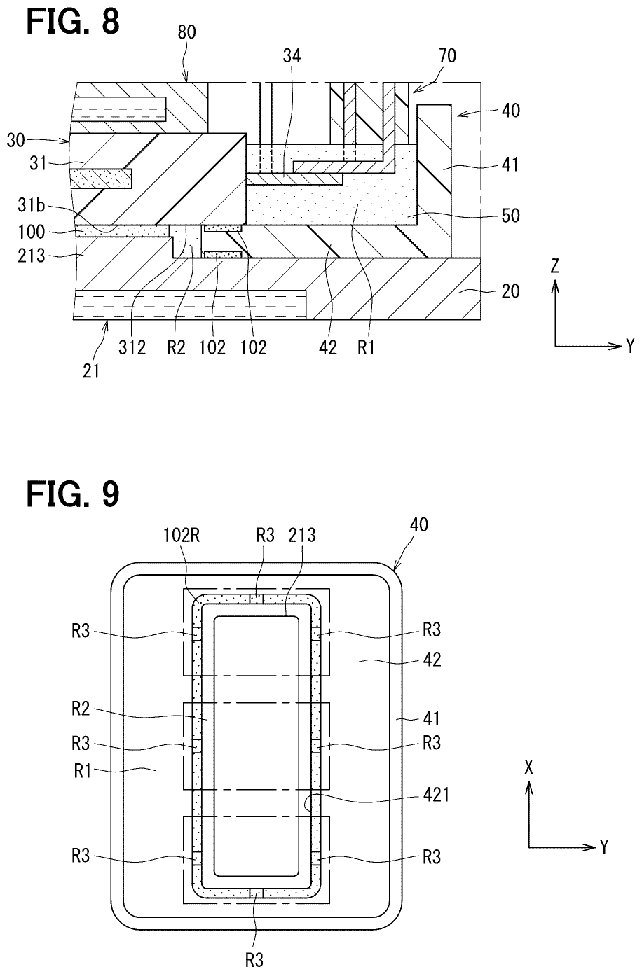

FIG. 8 shows a power conversion device 4 according to the present embodiment. FIG. 8 corresponds to FIG. 5. As shown in FIG. 8, an extension portion 42 of a frame 40 is in contact with a first cooler 21, similar to the preceding embodiment. The extension portion 42 is adhesively fixed to the first cooler 21 directly below a body portion 31. The extension portion 42 also contacts a back surface 31b of the body portion 31 in an end region 312. The extension portion 42 is adhesively fixed to the body portion 31. The extension portion 42 is in contact with the end region 312 of the body portion 31 via an adhesive 102.

FIG. 9 shows an area where the adhesive 102 is arranged, that is, an adhesive region 102R. For clarity, the adhesive region 102R is hatched. The adhesive region 102R indicates a region where the adhesive 102 is arranged in a plan view. The adhesive 102 on the lower surface side of the extension portion 42, i.e., the adhesive 102 between the extension portion 42 and the surrounding portion of the protrusion of the first cooler 21, is provided in an annular shape so as to surround a convex portion 213. The adhesive 102 on the lower surface side is provided over the entire adhesive region 102R. The arrangement of the adhesive 102 on the lower surface side is the same as in the preceding embodiment.

The adhesive 102 on the upper surface side of the extension portion 42, i.e., the adhesive 102 between the extension portion 42 and the end region 312 of the body portion 31, is provided in a portion that overlaps with the body portion 31 in a plan view. The adhesive 102 on the upper surface side is provided in a portion of the adhesive region 102R that overlaps with the body portion 31. Further, a communication hole that provides a region R3 is provided in a connection portion made of the adhesive 102 on the upper surface side. That is, the region R3 is provided in a part of the portion overlapping with the body portion 31. In the present embodiment, a plurality of regions R3 are arranged in a dispersed manner. Each of the regions R3 communicates with regions R1 and R2. The regions R1 and R2 are in communication with each other at positions between the adjacent semiconductor modules 30. The other configurations are similar to those described in the preceding embodiment (see FIGS. 2 to 6).

### Summary of Second Embodiment

According to the present embodiment, as in the preceding embodiment, even when a gap 110 occurs in a sealing member 50 directly below the semiconductor module 30, the extension portion 42 of the frame 40 can increase an along-surface distance between the main terminal 34 and the first cooler 21. Therefore, the insulation reliability is improvable.

Further, the extension portion 42 is in contact with the body portion 31. When the sealing member 50 is filled into the region surrounded by the frame 40, the contact portion restricts the movement of the sealing member 50 from the region R1 to the region R2. Therefore, leakage of the sealing member 50 from the gap between the extension portion 42 and the first cooler 21 is suppressible. In particular, in the present embodiment, the extension portion 42 is adhesively fixed to the body portion 31. Therefore, the effect of suppressing leakage from the sealing member 50 is improvable.

As an example, in the present embodiment, the extension portion 42 is adhesively fixed to the back surface 31b of the body portion 31, and the region R3 formed by a communication hole is provided. When the sealing member 50 is filled, the sealing member 50 flows from the region R1 through the region R3 to the region R2, thereby the region R2 is reliably fillable by the sealing member 50. That is, in a configuration in which the extension portion 42 is adhesively fixed to the body portion 31, the sealing member 50 is continuously arrangeable in the three regions R1, R2, and R3. Therefore, pump-out of the thermally conductive member 100 is suppressible.

### Modification

Although an example has been shown in which the extension portion 42 is adhesively fixed to the body portion 31, that is, in which the extension portion 42 contacts the body portion 31 via the adhesive 102, the present disclosure is not limited to the above. The extension portion 42 may be in direct contact with the body portion 31 without the adhesive 102 interposed therebetween. The contact can restrict the movement of the sealing member 50 between the extension portion 42 and the body portion 31, thereby suppressing leakage of the sealing member 50.

Although an example has been shown in which the extension portion 42 contacts the body portion 31 and the first cooler 21, the present disclosure is not limited to the above. The extension portion 42 may contact only the body portion 31. The extension portion 42 may be adhesively fixed only to the body portion 31.

The number and arrangement of the communication holes that provide the region R3 are not limited to the above example. For example, only one communication hole (region R3) may be provided.

### Third Embodiment

The present embodiment is a modification of preceding embodiment as a basic configuration and may incorporate description of the preceding embodiment. In the preceding embodiment, the tip of the extension portion is spaced apart from the side surface of the protrusion. Alternatively, a tip of an extension portion may be brought into contact with a side surface of a protrusion.

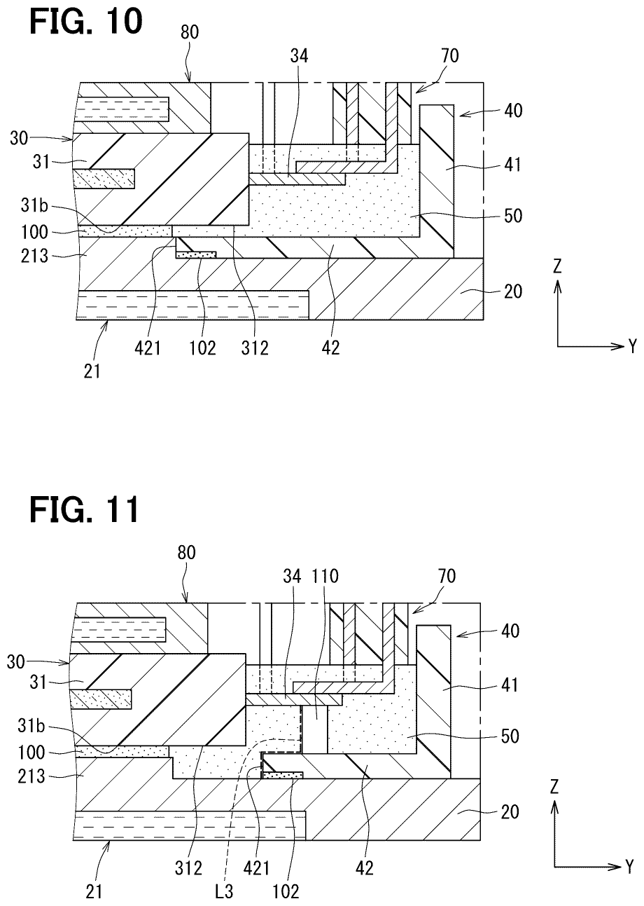

FIG. 10 shows a power conversion device 4 according to the present embodiment. FIG. 10 corresponds to FIG. 5. As shown in FIG. 10, an extension portion 42 of a frame 40 is in contact with a first cooler 21, similar to the preceding embodiment. The extension portion 42 is adhesively fixed to a first cooler 21. The extension portion 42 extends into a position between an end region 312 of a body portion 31 and the first cooler 21. A tip 412 of the extension portion 42 is in contact with a side surface of a convex portion 213 of the first cooler 21.

As an example, in the present embodiment, a gap exists at a position between a back surface 31b of the body portion 31 and an upper surface of the extension portion 42. A sealing member 50 is also disposed in such gap. The other configurations are similar to those described in the preceding embodiment (see FIGS. 2 to 6).

### Summary of Third Embodiment

According to the present embodiment, as in the preceding embodiment, even when a gap 110 occurs in the sealing member 50 directly below the semiconductor module 30, the extension portion 42 can increase an along-surface distance between the main terminal 34 and the first cooler 21. Therefore, the insulation reliability is improvable.

Further, the tip 421 of the extension portion 42 is in contact with the side surface of the convex portion 213 of the first cooler 21. Further, the sealing member 50 is arranged in the gap between the back surface 31b of the body portion 31 and the upper surface of the extension portion 42. Therefore, similar to the preceding embodiment, pump-out of the thermally conductive member 100 is suppressible.

### Modification

Although an example has been given in which the sealing member 50 disposed in the gap is used to suppress pump-out of the thermally conductive member 100, the present disclosure is not limited to the above. For example, by arranging the tip 421 of the extension portion 42 so as to close an opposing region between the convex portion 213 and the body portion 31, the extension portion 42 may contribute to suppression of pump-out of the thermally conductive member 100. Pump-out may be suppressed by both of the sealing member 50 and the extension portion 42.

The configuration described in the present embodiment is combinable with either of the configuration described in the first embodiment or the configuration described in the second embodiment. For example, in a configuration in which the extension portion 42 is adhered to both of the first cooler 21 and the body portion 31, the tip 421 of the extension portion 42 may be brought into contact with the side surface of the convex portion 213.

### Fourth Embodiment

The present embodiment is a modification of preceding embodiment as a basic configuration and may incorporate description of the preceding embodiment. In the preceding embodiment, the extension portion extends into a position where it overlaps with the body portion. Alternatively, an extension portion may extend into a position where it overlaps with a protruding portion of a main terminal.

FIG. 11 shows a power conversion device 4 according to the present embodiment. FIG. 11 corresponds to FIG. 5. FIG. 11 shows, as an example, a state in which a gap 110 is generated. As shown in FIG. 11, an extension portion 42 of the frame 40 is in contact with a first cooler 21, similar to the preceding embodiment. The extension portion 42 is adhesively fixed to a first cooler 21. The extension portion 42 does not overlap with a body portion 31 in a plan view. The extension portion 42 does not extend into a position between an end region 312 of the body portion 31 and the first cooler 21. A tip 421 of the extension portion 42 is positioned outside the body portion 31.

The extension portion 42 is arranged so as to overlap the protruding portion of a main terminal 34 in a plan view. The extension portion 42 may be arranged so as to overlap at least a portion of the protruding portion of the main terminal 34 in the extension direction of the protruding portion. A longer overlap length is preferred. As an example, the extension portion 42 in the present embodiment extends to the vicinity of the side surface of the body portion 31 in a plan view. The other configurations are similar to those described in the preceding embodiment (see FIGS. 2 to 6).

### Summary of Fourth Embodiment

According to the present embodiment, even when a gap 110 occurs in a sealing member 50 directly below the protruding portion of the main terminal 34 as shown in FIG. 11, the extension portion 42 positioned directly below the main terminal 34 can lengthen an along-surface distance L3 between the main terminal 34 and the first cooler 21. Therefore, the insulation reliability is improvable.

### Modification

Although an example in which the extension portion 42 is adhesively fixed to the first cooler 21 (base 20) has been shown, the present disclosure is not limited thereto. The extension portion 42 may be in direct contact with the first cooler 21 without the adhesive 102 interposed therebetween.

Although an example in which the first cooler 21 has the convex portion 213 has been described, the present disclosure is not limited to the above. In a configuration in which the tip 421 of the extension portion 42 is positioned outside the side surface of the body portion 31, the configuration may drop the convex portion 213.

### Fifth Embodiment

The present embodiment is a modification of preceding embodiment as a basic configuration and may incorporate description of the preceding embodiment. In the preceding embodiment, the extension portion contacts the first cooler and/or the body portion. Alternatively, an extension portion may be configured not to contact a first cooler and a body portion.

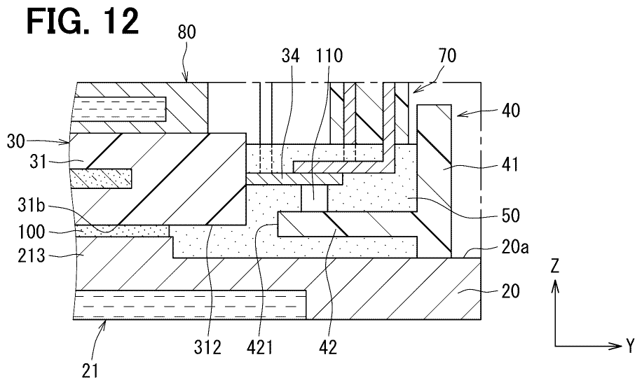

FIG. 12 shows the power conversion device 4 according to the present embodiment. FIG. 12 corresponds to FIG. 5. FIG. 12 shows, as an example, a state in which a gap 110 is generated. As shown in FIG. 12, an extension portion 42 of a frame 40 is arranged at a position spaced apart from one surface 20a of a base 20. The extension portion 42 extends inward not from a lower end of an outer circumferential wall portion 41 but from midway therethrough. As an example, the extension portion 42 of the present embodiment is arranged so as to overlap the protruding portion of a main terminal 34 in a plan view, similar to the fourth embodiment. A tip 421 of the extension portion 42 is positioned outside the side surface of the body portion 31 in a plan view.

### Summary of Fifth Embodiment

According to the present embodiment, the extension portion 42 is not in contact with the first cooler 21 and the body portion 31. The extension portion 42 is arranged above the first surface 20a of the base 20 so as to overlap with the protruding portion of the main terminal 34 in a plan view. Therefore, even when the gap 110 occurs in the sealing member 50 directly below the protruding portion of the main terminal 34 as shown in FIG. 12, the extension portion 42 positioned directly below the main terminal 34 can increase the along-surface distance between the main terminal 34 and the first cooler 21. Therefore, the insulation reliability is improvable.

### Modification

The extension portion 42 may be configured to extend to a position overlapping the body portion 31 in a plan view without contacting the first cooler 21 and the body portion 31.

### Other Embodiments

The disclosure in the present specification and drawings is not limited to the exemplified embodiments. The present disclosure encompasses embodiments described above and modifications of the above-described embodiments made by a person skilled in the art. For example, the present disclosure is not limited to a combination of the components and/or elements described in the embodiments. The disclosure may be implemented in various combinations. The disclosure may have additional components that can be added to the embodiments. The disclosure also includes modifications from which components/elements of the above-described embodiments are omitted. The present disclosure includes replacements of components and/or elements between one embodiment and other embodiment, or combinations of components and/or elements between one embodiment and other embodiment. The technical scope disclosed in the disclosure is not limited to the description of the embodiments. It should be understood that some of the disclosed technical scopes are indicated by claims, and the present disclosure further includes modifications within an equivalent scope of the claims.

The disclosure in the specification, drawings and the like is not limited by the description of the claims. The disclosures in the specification, the drawings, and the like include the technical ideas described in the claims, and further extend to a wider variety of technical ideas than those described in the claims. Therefore, various technical ideas can be extracted from the disclosure of the specification, the drawings and the like without being limited to the description of the claims.

When it is mentioned that a certain element or layer is “on”, “coupled”, “connected”, or “bonded”, the certain element or layer may be directly on, coupled, connected, or bonded to another element or layer, or an interposed element or an interposed layer may be present. In contrast, when it is mentioned that a certain element is “directly on”, “directly coupled”, “directly connected”, or “directly bonded” to another element or layer, no interposed element or interposed layer is present. Other words used to describe a relationship between elements should be interpreted in the similar manner (for example, “between” and “directly between”, “adjacent to” and “directly adjacent to”). When used in the description, the term “and/or” includes any of and all combinations related to one or multiple associated listed items.

Spatial relative terms “inside”, “outside”, “back”, “bottom”, “low”, “top”, “high”, etc. are used herein to facilitate the description that describes relationships between one element or feature and another element or feature. Spatial relative terms can be intended to include different orientations of a device in use or operation, further to the orientations depicted in the drawings. For example, when the device in the drawing is flipped over, an element described as “below” or “directly below” another element or feature is directed “above” the other element or feature. Therefore, the term “below” can include both above and below. The device may be oriented in the other direction (rotated 90 degrees or in any other direction) and the spatially relative terms used herein are interpreted accordingly.

The vehicle drive system 1 is not limited to the above configuration described above. Although, for example, the present disclosure describes that one motor generator 3 is provided, the present disclosure is not limited thereto. A plurality of motor generators may be provided therein.

Although an example in which the power conversion device 4 includes the inverter 5 as the power conversion circuit has been described, the present disclosure is not limited thereto. For example, a plurality of inverters may be provided therein. At least one inverter and a converter may be provided in configuration. Only a converter may be provided.

The number of semiconductor modules 30 is not limited to the above example. For example, one semiconductor module 30 may provide one arm 10H, 10L. In such a case, the inductance is reducible by arranging in parallel (a) the main terminal electrically connected to the drain electrode and (b) the main terminal electrically connected to the source electrode. Also, one semiconductor module 30 may provide six arms 10H, 10L.

Although an example of the power conversion device 4 having a two-stage cooling structure has been shown, the present disclosure is not limited to the above. The power conversion device 4 may include at least a base 20 having a first cooler 21 (cooler), a semiconductor module 30, a frame 40, and a sealing member 50.

### Disclosure of Technical Idea

The embodiments teaches multiple technical features described in multiple items listed below. Some items may be written in a multiple dependent form with subsequent items referring to the preceding item as an alternative. Alternatively, some features may be described in a multiple dependent form referring to another multiple dependent form. These features described in a multiple dependent form define multiple technical features.

### Technical Idea 1

A power conversion device includes: a base (20) provided with a cooler (21); a semiconductor module (30) that includes a body portion (31) including a semiconductor element, and a plurality of main terminals (34) including parallel terminals arranged side by side with each other and protruding from the body portion, the semiconductor module (30) being stacked on the cooler; a frame (40) fixed to the base and arranged around the semiconductor module in a plan view of a stacking direction in which the cooler and the semiconductor module are stacked; and a sealing member (50) having an electrically insulation and filled in a region that is surrounded by the frame and seals the main terminal. In the power conversion device, the frame includes (i) an outer peripheral wall portion (41) that surrounds the semiconductor module in the plan view, and (ii) an extension portion (42) that is made of an electrically insulating material, extends from the outer peripheral wall portion to a position that overlaps with the semiconductor module in the plan view, and is positioned between the semiconductor module and the cooler in the stacking direction.

### Technical Idea 2

In the power conversion device according to Technical Idea 1, the cooler has a convex portion (213) that supports the body portion in the plan view, the body portion includes an overlapped region (311) which is a region overlapping with the convex portion in the plan view, and an end region (312) which is a region outside the overlapped region and is not overlapped with the convex portion in the plan view, and the extension portion extends to a position to be overlapped with the end region of the body portion in the plan view.

### Technical Idea 3

In the power conversion device according to Technical Idea 1 or 2, the extension portion is in contact with the cooler and/or the body portion.

### Technical Idea 4

In the power conversion device according to Technical Idea 3, the extension portion is adhesively fixed to the cooler and/or the body portion.

### Technical Idea 5

The power conversion device according to Technical Idea 3 or Technical Idea 4 further includes a heat conductive member (100) interposed between the convex portion of the cooler and the body portion. In this case, the sealing member is continuously arranged in (i) a first region (R1) defined to include the body portion and the semiconductor module and in which the main terminal is arranged, (ii) a second region (R2) defined to include the end region of the body portion, the cooler, and a tip of the extension portion, and (iii) a communication region (R3) positioned between the first region and the second region and communicating with the first region and the second region.

### Technical Idea 6

The power conversion device according to Technical Idea 3 or Technical Idea 4 further includes a heat conductive member (100) interposed between the convex portion of the cooler and the body portion. In this case, a tip of the extension portion is in contact with a side surface of the convex portion.

### Technical Idea 7

The power conversion device according to any one of Technical Ideas 1 to 6 further includes: a second cooler (80) arranged at a position to sandwich the body portion between the second cooler and the cooler as a first cooler, in the stacking direction. In this case, the outer peripheral wall portion is arranged at a position closer to the base than the second cooler and extends across the second cooler in the plan view of the stacking direction, and a surface of the sealing member is closer to the first cooler in the stacking direction than a lower surface, which is a surface of the second cooler facing the body portion.

### Technical Idea 8

In the power conversion device according to Technical Idea 7, the outer peripheral wall portion includes a recess (43) at a portion facing the second cooler, and a filler member (101) is arranged to fill a gap between a wall surface of the recess and the second cooler.

What is claimed is:

1. A power conversion device comprising:
a base provided with a cooler;
a semiconductor module that includes a body portion including a semiconductor element, and a plurality of main terminals including parallel terminals arranged side by side with each other and protruding from the body portion, the semiconductor module being stacked on the cooler;
a frame fixed to the base and arranged around the semiconductor module in a plan view of a stacking direction in which the cooler and the semiconductor module are stacked; and
a sealing member having an electrically insulation and filled in a region that is surrounded by the frame and seals the main terminal, wherein
the frame includes (i) an outer peripheral wall portion that surrounds the semiconductor module in the plan view, and (ii) an extension portion that is made of an electrically insulating material, extends from the outer peripheral wall portion to a position that overlaps with the semiconductor module in the plan view, and is positioned between the semiconductor module and the cooler in the stacking direction.

2. The power conversion device according to claim 1, wherein
the cooler has a convex portion that supports the body portion in the plan view,
the body portion includes an overlapped region which is a region overlapping with the convex portion in the plan view, and an end region which is a region outside the overlapped region and is not overlapped with the convex portion in the plan view, and
the extension portion extends to a position to be overlapped with the end region of the body portion in the plan view.

3. The power conversion device according to claim 1, wherein
the extension portion is in contact with at least one of the cooler and the body portion.

4. The power conversion device according to claim 3, wherein
the extension portion is adhesively fixed to the at least one of the cooler and the body portion.

5. The power conversion device according to claim 3, further comprising:
a heat conductive member interposed between the convex portion of the cooler and the body portion, wherein
the sealing member is continuously arranged in (i) a first region defined to include the body portion and the semiconductor module and in which the main terminal is arranged, (ii) a second region defined to include the end region of the body portion, the cooler, and a tip of the extension portion, and (iii) a communication region positioned between the first region and the second region and communicating with the first region and the second region.

6. The power conversion device according to claim 3, further comprising:
a heat conductive member interposed between the convex portion of the cooler and the body portion, wherein
a tip of the extension portion is in contact with a side surface of the convex portion.

7. The power conversion device according to claim 1, further comprising:
a second cooler arranged at a position to sandwich the body portion between the second cooler and the cooler as a first cooler, in the stacking direction,
the outer peripheral wall portion is arranged at a position closer to the base than the second cooler and extends across the second cooler in the plan view of the stacking direction, and
a surface of the sealing member is closer to the first cooler in the stacking direction than a lower surface, which is a surface of the second cooler facing the body portion.

8. The power conversion device according to claim 7, wherein
the outer peripheral wall portion includes a recess at a portion facing the second cooler, and
a filler member is arranged to fill a gap between a wall surface of the recess and the second cooler.
